(19) United States
(12) Patent Application Publication
(10) Pub. No.: US 2016/0287979 A1
(43) Pub. Date: Oct. 6, 2016

(54) A Modular Connected Game Board System and Methods of Use

(71) Applicant: SEEBO INTERACTIVE, LTD., Tel Aviv (IL)

(72) Inventors: Lior Akavia, Tel Aviv (IL); Liran Akavia, Tel Aviv (IL); Lee Winfield, Tel Aviv (IL); Orl Lagziel, Givataim (IL); Yarden Hod, Tel Aviv (IL)

(21) Appl. No.: 15/038,141

(22) PCT Filed: Nov. 19, 2014
(86) PCT No.: PCT/IL2014/051004

§ 371 Date: May 20, 2016

Related U.S. Application Data
(60) Provisional application No. 61/907,334, filed on Nov. 21, 2013.
(60) Provisional application No. 61/936,890, filed on Feb. 7, 2014.

(51) Int. Cl. A63F 3/00; A63F 13/24; A63F 13/23; A63F 3/04; A63F 9/10

(52) U.S. Cl. CPC A63F 3/00643; A63F 3/04; A63F 3/0423; A63F 9/10; A63F 13/23; A63F 13/24; A63F 2003/00662; A63F 2003/00652

(57) ABSTRACT

The invention is directed to modular connected game board having a generic game board base and at least one identifiable object, the game board base is configured to allow recognition of the identity and the position of the at least one identifiable object on the game board base upon positioning of said at least one identifiable objects on the game board base, and wherein, an image of said identifiable object is displayed on a smart device in a respective position, said smart device comprising a software program for identifying the identifiable object, and activating or deactivating the interaction of the game board base, the smart device, and the identifiable object. The identifiable object may be either one of a replaceable topping adapted to be placed on said game board base, said topping constitutes a unique game display, or an interactive figure associated with said unique game display, or both. The invention is further directed to a modular game board system for providing interactive play with a smart device, comprising: a game board base configured and operable to communicate with at least smart device and with at least one interactive figure; at least one replaceable topping adapted to be placed onto said game board base, said toppings constitutes a unique game display; at least one interactive figure associated with said unique game display; a sensor configured for sensing the location of the at least one interactive figure; a processing unit configured for receiving the sensor signals and for determining the identity and the location of the interactive figure based on the signal; and a communication module configured for commanding a software running on a smart device to display an image of said interactive figure and/or said replaceable topping on said smart device in a respective position, and for commanding the software to activate or deactivate the image in accordance with operation of the interactive figures on the game board base.

### FIELD OF THE INVENTION

The present invention relates generally to the field of interactive connected toys. More specifically, the invention relates to a modular connected game board system that allows a user to change themes of the game board system by using different playing kits, wherein the modular game board is capable of connecting to various smart devices, one at a time, that comprises a dedicated software application/s (“app”) installed on them.

### BACKGROUND OF THE INVENTION

In the past several years, there have been many developments in the field of interactive playing boards. An example of such attempt is the 1.2.3. Play & Learn Farm from Playmobil™ (http://www.ebay.com/bhp/playmobil-123-farm) that allows recognition of toy elements upon positioning of these elements on a specific spot on the play board based on RFID recognition. However, this board is limited to one specific design/structure with a set of toy elements suitable for a specific design, it comprises only one spot in which the toy elements can be identified, and has no connectivity to a smart device. Thus, the user interface and the playing experience is fixed and limited. Another example for interactive playing board is the Touch Magic Discovery Town of Leapfrog™ (http://www.youtube.com/watch?v=gW6Y5PGI5Nw). This board provides a user a single playing option with no connectivity to a smart device and no additional detachable interactive figures, but rather a simple touching of predefined spots on the board that creates an audio reaction. Thus, the user interface as well as the playing experiences is very limited. Another example is the Apptivity Barn by Fisher Price™ http://www.youtube.com/watch?v=wZa1FItbsMs) that allows recognition of toy elements in various locations upon a tablet, but the identification is totally dependent on the tablet screen, and therefore the same board cannot be connected to many other devices, such as PC, smart TV, smart watch and different sizes of tablets and smart phones. In addition, using the tablet as the identification surface is less protective for the tablet, and the presented virtual content might be limited since the figures must be placed on the screen and therefore they block the field of vision.

U.S. Pat. No. 5,853,327 relates to an electronic game board system comprising a game board surface; an excitation signal generator which generates an electromagnetic query signal; a plurality of playing pieces positioned on the game board surface, each piece including a transponder which receives the query signal and, in response thereto, generates an identifying answer signal. The board also includes a plurality of sensors which, upon receipt of the answer signal, generate a plurality of sensor signals responsive to the location of at least one playing piece for automatically and non-discretely sensing the location of the playing pieces. The system also includes a processing unit that receives the sensor signals and determines the identity and location of the playing piece based on the signal. The processing unit is then operative to actuate an audio/visual display sequence in response to the location of the playing piece. The game board system has the disadvantage that it is not designed to connect remotely to a smart device. Also, the game board surface does not allow for any variability between the types of the games that are played.

Another electronic game is disclosed in US Patent Application No. 2006246403. This invention employs pieces having radio-frequency tags each provided with an individual identification code. The game board comprises a digital processing unit which detects the presence of the pieces.

US Patent Application No. 2011098092 discloses a video game having a reader that senses the identity of various game objects. The game objects each have an RFID tag or other identification device that is identified by the reader.

U.S. Pat. No. 7,050,754 relates to a system where a player arranges computer-recognizable characters on a working platform to spell words or provide a mathematical result in response to computer-generated questions or prompts.

Other interactive game systems are disclosed in US Patent Application No. 2012052934, U.S. Pat. No. 8,025,573, U.S. Pat. No. 70008316, US Patent Application No. 2006007795 and in the following publications: http://www.purplepawn.com/2010/10/conductive-ink-a-new-paradigm-for-interactive-board-games/, and http://www.which.co.uk/baby-and-child/shopping-and-family-finances/guides/apps-for-pregnancy-parents-and-kids/toys-with-apps/

Many of the electric game systems known in the art included a dedicated display means associated with the game system. Others are configured to connect the system to a desktop of computer.

The present invention introduces a modular interactive game platform that interfaces with non-dedicated smart devices. The game platform comprised a board base configured to serve as a platform that can be used for an endless number of different game types and themes, for a range of ages and for a variety of players with different personal preferences, according to the playing kit that is used with the modular game board base.

### SUMMARY OF THE INVENTION

The invention is directed to a game board system that is modular in every aspect. For example, it is configured to allow the user to place different play kits on it, and enjoy a different game application and play-pattern each time the player uses the system. The term “play kit” as used herein is directed to a play set that may be used for playing with the modular game board base. The play kit components may vary and may comprise base toppings in various shapes, and designs, interactive figures and decorative elements as will be described in details below. The play kit may comprise only toppings or interactive figures or decorative elements or a mixture thereof related to a specific theme.

The player may connect with the same play kit to various smart devices available to the player according to its preferences in a given time. For example, the player may be connected to a tablet and if another member in the family needs the tablet, the payer may connect to a smart T.V. or to a smart phone and proceed with the game at the same course he had before changing the connected smart device as the main “brain” is positioned in the modular play board.

The term “Smart device” as used herein, includes every electronic device that has the ability to connect to peripheral devices (a wired connection or wirelessly, such as Bluetooth, BLE, Wi-Fi etc.), and which usually allows to install a dedicated software application (app). Examples for smart devices are, but not limited to, smart phones, smart TVs, smart watches, tablets, and phablets. The two-way communication between the game board base and the smart device allows for a fully connected modular interactive play experience. In accordance with the subject matter disclosed herein, different games for the same play-set may be available for different smart devices. For example, a smart TV may have a different app than a tablet as the tablet allows functions suitable for a touch screen that are not functional while using a smart TV as the smart device for the board system. It should be clear that in many other options of implementation of the invention the same app may be used by all the smart devices connected thereto.

The subject matter disclosed herein have a number of unique advantages that are not known or available in the prior art. Firstly, the modular game board system of the present invention provides a platform for a limitless number of game applications and uses, depending on the type of topping and/or interactive figures that is used with it. Each topping represents a unique game display, and has different interactive figures associated therewith. After a topping is placed on the modular board base, one or more interactive figures (for non-limited example, a car, a doll, an animal, etc.) associated with the chosen topping is can be put on the board base, at predetermined optional locations thereon. Placement, movement, and other actions performed with the interactive figure on the board and optionally on the interactive figures, are recognized by the smart device app and actuate responses in the app of the smart device that is in communication with the board base. The board may also include LED's, buttons, buzzers, speakers, and other accessory items for enhancing the play experience.

In some implementations of the invention, a topping is not required and the player may place interactive figures directly on the board base, for example to teach letters, numbers, animals and the like. Upon placement of the interactive figure on the board base a sound and/or a representative illustration of the figure are displayed on the smart device that enhances the playing experience. The term: “Theme” as used herein refers to the subject of the game being played by the player at a specific moment. The game theme can be composed of figures, and/or toppings, and/or decorative elements. Each theme may have a dedicated app. In some implementation of the invention, the topping may also be recognized by the app. In such variation, one possible theme may include several toppings and a single interactive figure, and the game will be about changing the toppings for the same character.

The modular board base system can provide interactive play experience for various ages. For young children, for example, by using simple toppings and interactive figures representative of a farm, a road, a castle, colors, etc. For older children, the topping and interactive figures can be designed with more advanced educational and/or entertainment goals in mind.

In the context of the present invention, the term “Topping” refers to a game display element which is configured to be fitted onto the game board base in order to provide a unique game theme and setting for the user. Attachment means may be included to facilitate the connection between the topping and the board base, for example, so that the topping does not move while it is being played with. The topping can be fitted onto any appropriate portion or portions of the base boards, such as, but not limited to, the top and/or one of the sides. The topping can be comprised a flat surface having images depicted thereon of a certain play setting. The topping may be three-dimensional, or have some three-dimensional components which stand on the flat surface. The topping outer surface may be smooth or may have textures on the entire surface or on specific areas, so as to enhance the playing experience of the player. In a similar concept, when the game board base functions as the upper surface with no topping positioned over it, it may also be made of smooth material or it may have different textures.

Once an identifiable object is positioned on the board, the user may connect the matching application in the smart device. This can be done automatically (for example, when placing an identified topping or an identified interactive figure, the topping/the figure sends a message to a predefined smart device to open a particular application), or manually, simply by selecting and activating the matching app. The application may include a dedicated game that matches a specific kit. For example, if a safari kit is placed (safari designed topping and interactive animal's figures), the application may involve different games around the safari. Every activity made on the physical board (for example: placing the lion near the cave) may be reflected in the application.

The possible applications and kits are unlimited, and can be taken from various game fields and play patterns. For example, a kit may include interactive figures that are the letters of the alphabet, with no topping at all. The suitable application may teach children how to write basic words, simply by identifying the location of the letters on the board (C on the left, A in the middle and T in the right will make CAT). In another example, the kit consist only different cardboard toppings, which can be identified by the board. In this example, the suitable application may include puzzles, pair games or construction. In yet another example, the kit may include a 3d topping of a castle, and interactive figures of different magical soldiers. The suitable app might include a quest, an adventurous game about defending the castle, or even a creative game that allows the player to create a magic kingdom story. The modular board game, allow a versatile play pattern with endless features of play.

This advantage allows the user to play different games having different themes and characters on a single game board base, simply by replacing the playing kit and the application. It also allows different users with different game preferences (for example, two brothers in different ages), to play on the same base board with two different application.

The game board base comprises recognition elements that recognize the interactive figures as they are placed and moved around on the topping. In preferred embodiments, the recognition elements employ one or more of the following technologies: resistors, NFC, capacitive sensors, ultrasonic triangulation, photo-sensors, and camera. Information is transmitted form the board base to a smart device such that an image of the interactive figure(s) appears on the screen of the smart device. When a second interactive figure is placed on the board, that figure is also recognized by the base so that an image of it may also appear on the screen of the smart device in a respective position to its physical position on the board. For example, if an interactive figure is placed on the left side of the board, a possible application may reflect the location perceptively (show the figure on the left side of the smart device's screen). When a figure is lifted out of the board, the application may respond to the lifting, for example by showing the figure jumping up, exiting from the left or waving goodbye. Every activity on the physical board may be transferred to the smart device, by a wired connection or wirelessly, in means like Bluetooth, BLE, Wi-Fi, etc. Once the information is transmitted, the application will respond to the activity, and vice versa.

In another example, the player may use the application on the smart device in order to operate things in the board. For example, the player may press an object inside the application in order to activate a speaker or a buzzer that is placed inside the physical board.

In one embodiment, each of the toppings positioned on the board base have a different software application (“app”) that is associated therewith. The app is preferably activated when an interactive figure for the specific topping or the topping itself that is being used are placed on the game board base. An image of the interactive figure then appears on the screen of the smart device, along with a background that represents that of the chosen topping. Alternatively, the same app may be configured to be used with a plurality of different toppings and themes.

The user can play by manipulating the interactive figures on the top surface of the board, which produces a response on the screen of the smart device. Actions can also be taken using the smart device itself, producing different responses on the game board base.

### BRIEF DESCRIPTION OF THE DRAWINGS

Examples illustrative of variations of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. The figures presented are in the form of schematic illustrations and, as such, certain elements may be drawn greatly simplified or not-to-scale, for illustrative clarity. The figures are not intended to be production drawings.

FIG. 1 is a schematic exploding view of a modular game board comprising a board base and a topping in accordance with one variation of the present invention.

FIGS. 2A to 2C are schematic top view, isometric view, and bottom view illustrations, respectively, of one example of a modular board base of the present invention.

FIGS. 2D and 2E are top and isometric views, respectively, of another example of a modular board base of the present invention.

FIGS. 2F and 2G are top and isometric views, respectively, of yet another example of the modular board base of the present invention.

FIGS. 2H and 2I are top and isometric views, respectively, of a multi heights modular game board base of the present invention.

FIGS. 3A-3B are schematic illustrations of two exemplifying variations of replaceable toppings. In FIG. 3A, the topping represents an urban environment with a traffic road and in FIG. 3B the topping represents a nature setting.

FIG. 4 is a schematic illustration of a modular game board having a three dimensional (3D) “active” topping, in accordance with embodiments of the present invention.

FIG. 5 is a schematic illustration of a modular game board having a game board base with an integral topping and an interactive figure with mechanical elements.

FIGS. 6A-6L are schematic illustrations of examples of interactive figures in accordance with the invention including, wherein, FIGS. 6A-6D are family set figures with a girl (FIG. 6A), a boy (FIG. 6B, a mother (FIG. 6C), and a father (FIG. 6D); FIGS. 6E-6H are safari set figure with a monkey (FIG. 6E), a lion (FIG. 6F), a giraffe (FIG. 6G), and an elephant (FIG. 6H); FIGS. 6I-6L are traffic vehicles set with a car (FIG. 6I), an helicopter (FIG. 6J), a boat (FIG. 6K), and a train locomotive (FIG. 6L); FIGS. 6M and 6N represent a side view and a front view, respectively, of a smart interactive figure designed as a helicopter with LEDs and mechanical propeller.

FIG. 7A-7E are schematic illustration of examples of decorative elements for enriching the physical playing environment in accordance with embodiments of the invention, wherein FIG. 7A illustrates a school, FIGS. 7B-7C illustrate a bakery viewed from front and rear sides respectively, FIG. 7D illustrates a fence, and FIG. 7E illustrates a tree.

FIGS. 7F and 7G are schematic views of smart decorative elements capable of performing a reaction in the physical toy.

FIGS. 8A-8D are schematic illustrations of the modular game board system in different combinations and modes of play. FIGS. 8A-8B showing a system comprising a game board base, two interactive figures and a smart device, wherein FIG. 8A illustrates “record play mode”, and FIG. 8B illustrates “share play mode”; FIG. 8C illustrates a modular game board system comprising a game base, a replaceable topping, an interactive figure, decorative elements, and a smart device having a dedicated software running on it that allows representation of the physical game board components on the smart device in a respective position; FIG. 8D illustrates a modular game board system having a game board base, two interactive figures, a solder and a cannon, positioned on a 3D smart interactive figure, wherein, the cannon is a smart interactive figures with abilities to cause a further reaction, and a smart device displaying via a dedicated app the interactive figs. in a “record” play mode.

### DETAILED DESCRIPTION OF PREFERRED EMBODIMENTS

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

The modular game board system provided herein is an electronic connected toy having ability to connect to smart devices such as but not limited to, smart phones, tablets, phablets, smart TVs, smart watches and PC. For that purpose, various wireless and wired communication technologies may also be applied.

The subject matter disclosed herein is directed in one main aspect, to a modular game board comprising a generic game board base and at least one identifiable object, wherein the game board base is configured to allow recognition of the identity and the position of the at least one identifiable object on the game board base upon positioning of said at least one identifiable objects on the game board base, and wherein, an image of said identifiable object is displayed on a smart device in a respective position, said smart device comprising a software program for identifying the identifiable object, and activating or deactivating the interaction of the game board base, the smart device, and the identifiable object. The identifiable object may be either one of a replaceable topping adapted to be placed on said game board base, said topping constitutes a unique game display, or an interactive figure associated with said unique game display, or both. Upon recognition of the identifiable object and display of its image on the smart device, a further reaction is performed by the smart device and/or by the base board. The further reaction may be: a production of a sound, a mechanical movement of the interactive figure, and power on of a LED.

The image of the identifiable object displayed on the smart device may be either one of the following: a picture of the identifiable object, an animation of the identifiable object reflecting the reality of the game board base, animation of a story that involves the identifiable objects positioned at a specific moment on the board base, a song or a movie involving the identifiable objects that are in use, and connection to external software. The image of the identifiable object is preferably displayed on the smart device at a respective position to its position on the game board base. Upon recognition of the identifiable object and display of its image on the smart device a further reaction is performed by the smart device and/or by the game board base.

In some embodiments, the game board base further comprises at least one of the following components: buttons, LEDs, microphone, buzzer, and speaker. The game board base may further have a modular construction, which allows a user to change the topping and the interactive figures used with the board, thus allowing them to use the same physical board with multiple games. In a specific example, the game board base is comprised of two or more segments having varying heights.

The modular game board may further comprise least one smart interactive figure having at least one electric component that creates a reaction on the interactive figure itself upon usage. The electronic component may be a button, LED, and speaker.

The modular game board may further comprise attachment means for facilitating attachment of the identifiable objects to the game board base.

The replaceable topping may comprise at least one 3D standing element.

Another main object of the subject matter disclosed herein is directed to a modular game board system for providing interactive play with a smart device, comprising;
(a) a game board base configured and operable to communicate with at least smart device and with at least one interactive figure;
(b) at least one replaceable topping adapted to be placed onto said game board base, wherein each of said toppings constitutes a unique game display;
(c) at least one interactive figure associated with said unique game display;
(d) a sensor configured for sensing the location of said at least one interactive figure;
(e) a processing unit configured for receiving the sensor signals and for determining the identity and the location of said at least one interactive figure based on said signal; and
(f) a communication module, said communication module being configured for commanding a software running on a smart device to display an image of said interactive figure and/or said replaceable topping on said smart device in a respective position, and for commanding said software to activate or deactivate said image in accordance with operation of said interactive figures on said game board base, so as to simulate the environment of the modular game board to the display on the smart device.

The activation of the image further comprises one member of a group consisting of: moving the image of the interactive figure, playing an animation, playing a video clip, playing a recording file, and communicating with a social network.

The sensor is further configured for sensing the location of the replaceable topping, wherein the processing unit is further configured for receiving the sensor signals and for determining the identity and the location of said replaceable topping based on said signal.

The image of the interactive figure displayed on the smart device may be either one of the following: a picture of the interactive figure and/or the replaceable topping, an animation of the interactive figure and/or replaceable topping reflecting the reality of the game board base, animation of a story that involves the interactive figures positioned at a specific moment on the board base, a song or a movie involving the interactive figures that are in use, and connection to external software. The image of the interactive figure may be displayed on the smart device at a respective position to its position on the game board base.

Upon recognition of the interactive figure and display of its image on the smart device a further reaction is performed by the smart device and/or by the game board base. The further reaction may be, for example, a production of a sound, a mechanical movement of the interactive figure, and power on of a LED.

The game board base may comprise an integral topping having a unique game display. The game board base may further be configured to allow recognition of the identity and the position of the at least one replaceable topping on the game board base.

The smart device may be selected from a group consisting: smart phones, smart televisions, tablets, phablets, PC, and smart wearable devices.

The communication of the game board base with a specific smart device may be determined before each playing session.

In a further major aspect of the invention, a modular game board system for providing interactive play with a smart device is provided, said system comprising:
(a) a game board base configured and operable to communicate with at least smart device and with at least one element of a playing kit;
(b) a playing kit comprising at least one replaceable topping adapted to be placed onto said game board base, each topping constitutes a unique game display and/or at least one interactive figure associated with said unique game display; and
(c) a software program for activating or deactivating the interaction of the game board base with the smart device and the at least one element of the playing kit;
Wherein, the game board base is configured and operable to allow recognition of the identity and the position of said at least one element of the playing kit on the board, such that upon placement of said element on the game board base, said game board base transmits said identity and the position of the element to the smart device, causing at least a performance of an image of said element displayed on the smart device.

The playing kit may comprise a plurality of replaceable topping pieces constituting together a unique game display, or a plurality of interactive figures related to a unique game theme, or at least one replaceable topping and at least one interactive figure, all related to a unique game theme, or non-identifiable decorative elements configured to decorate the game board base and topping of the unique game them. The playing kit may be accompanied by a software application dedicated to the smart device being in use.

The game board base has at least one recognition element for recognizing either one of the interactive figure and the replaceable topping that are being placed thereon. The recognition element may be at least one hotspot configured to allow identification of said at least one replaceable topping and/or interactive figure when either one of them or both are placed onto said at least one hotspot. Each of the at least one interactive figures and/or replaceable topping has a unique tag for facilitating recognition of said figure or topping by the game board base.

The game board base may further comprise at least one of the following components: buttons, LEDs, microphone, buzzer, and speaker. the game board base has a modular construction, which allow users to change the topping and interactive figures used with the board, thus allowing them to use the same physical game board with multiple games.

The game board base may be comprised of two or more segments having varying heights.

The modular game board system may further comprise at least one smart interactive figure having at least one electric component that creates a reaction on the interactive figure itself upon usage. The electronic component may be a button, LED, and speaker.

The modular game board system may further comprise attachment means for facilitating attachment thereto of the replaceable topping. The topping may comprise at least one 3D standing element. Additionally or alternatively, the replaceable topping may be a 3D topping comprising an extension of sensors configured to allow identification of interactive figures positioned on top of it.

In accordance with main aspects of the invention the modular game board system comprises three main elements: a game board base, at least one replaceable topping, and at least one interactive figure. However, in specific embodiments, the game board system may comprise a game board base and multiple interactive figures, or a game board base and multiple toppings only. The system may further comprise decorative non-interactive figures. The interactive figures as well as the decorative figures may be simple or smart as will be described in details hereinafter.

### I. Game Board Base

The game board base is preferably but not necessarily made of a stiff material such as plastic, wood, and any other suitable material. The top surface of the game board base is configured to allow placement of a replaceable topping on it, however, the top surface of the board may serve by itself as an integral topping. In such variation, the user may play on the game board base without the need to position a separated topping on the board bas. The game board base contains the main electronic components of the toy, as well as a communication transmitter, such as but not limited to a Bluetooth transmitter, that is configured and operable to connect with different smart devices as mentioned above. In addition to the communication transmitter the following components are the major electronic elements that are housed in the game board base:

### 1. Recognition Elements

In accordance with embodiments of the present invention, the board base contains at least one recognition element based on various technologies including without limitation: RFID, NFC, capacitive sensors, ultrasonic triangulation and camera. In a preferred implementation of the invention the game board base comprises a plurality of recognition elements that provides the user a larger variety of game options and difficulty levels. The recognition element may be composed of two electronic components: a hotspot and a tag as described in details in PCT/IL2013/000055 of the same inventors incorporated herein by reference. In such embodiment, the hotspot component is embedded within the board base, while each tag is attached to one interactive figure. The identification of a specific tag/interactive figure that is being attached to a hotspot embedded in or attached to the game board base is obtained by reading the electronic resistance of the tag, as each tag has a different and unique electronic resistance.

### 2. Buttons

In accordance with one specific implementation of the invention, the board base contains at least one button configured to allow a player to control different game modes of the corresponding software app(s). The button/s may also be used in specific games for shooting, gestures, waking the board after a sleep mode and the like. Other buttons may be located on the figures and elements themselves, and thus may have a specific role in the game play, for example: a button located on an apple tree, pressing it drops an apple in the app. Another example: a button located on a guitar player interactive figure makes the guitar player change his music style and dance in the app.

The board may further contain a reset button. Although the button is not needed on a regular use, it may assist on rare occasions of bugs in the firmware.

### 3. LEDs

The base board may further contain LEDs. The LEDs may be at least of two types: connection LEDs configured and operable to serve as indicators for the connection between the board and the application (i.e. to indicate whether the board is connected to the app, trying to connect, or it is on a sleep/off mode); functional LEDs configured and operable to serve as indicators within the game itself, and contribute to the game functionality.

The number of electronic elements on the modular board, i.e. the number of LEDs, hotspots and buttons may vary in different versions of the modular board.

In accordance with one specific implementation of the invention the board base has a rectangular shape with rounded edges adapted for preventing children from being injured, and a slight curve on the front side of the board, preferably where the button/s are located.

In accordance with one another specific variation of the invention, the board base comprises a small dent with special slots on the sides that allows the user to switch the topping on the board as will be described hereinafter.

The game board base may also include other electric components, for enriching the experience of the game, such as: buzzers, speakers, microphone, piezoelectric sensors, potentiometers, touch sensor, and the like.

### 4. Power Supply

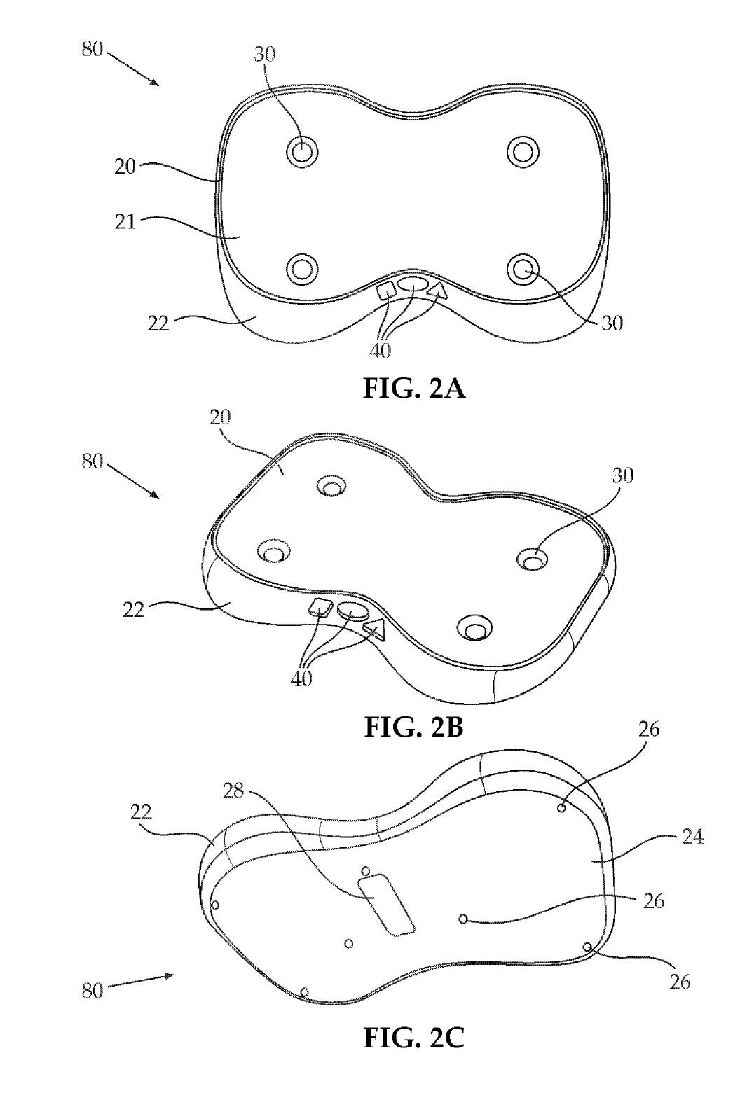

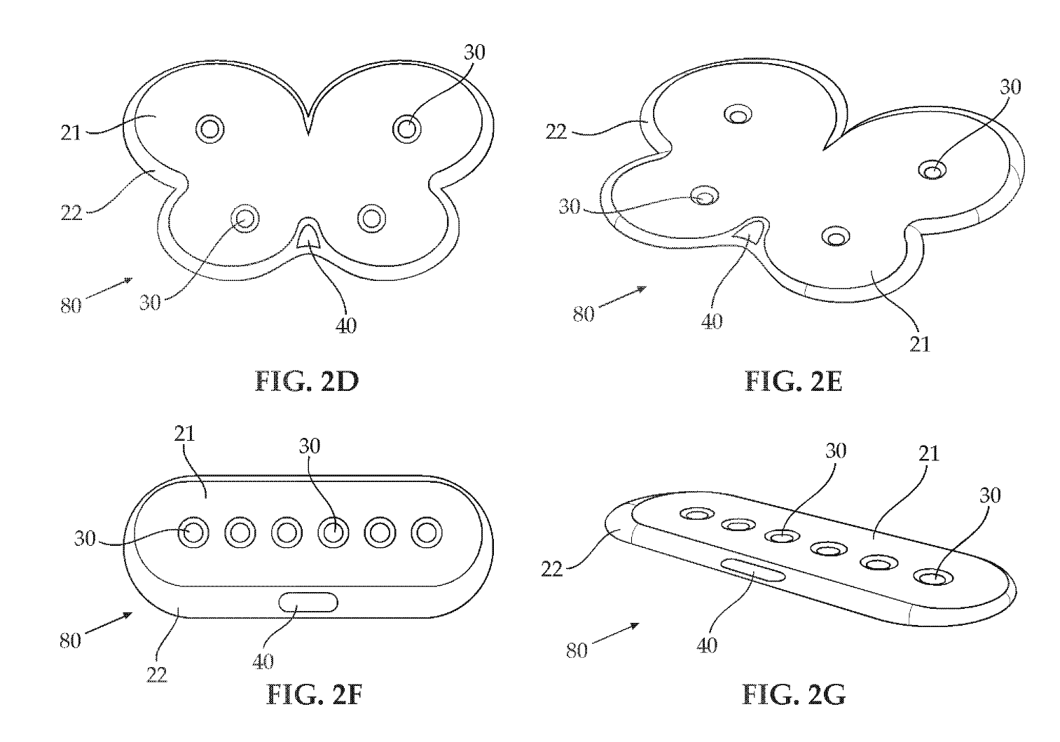

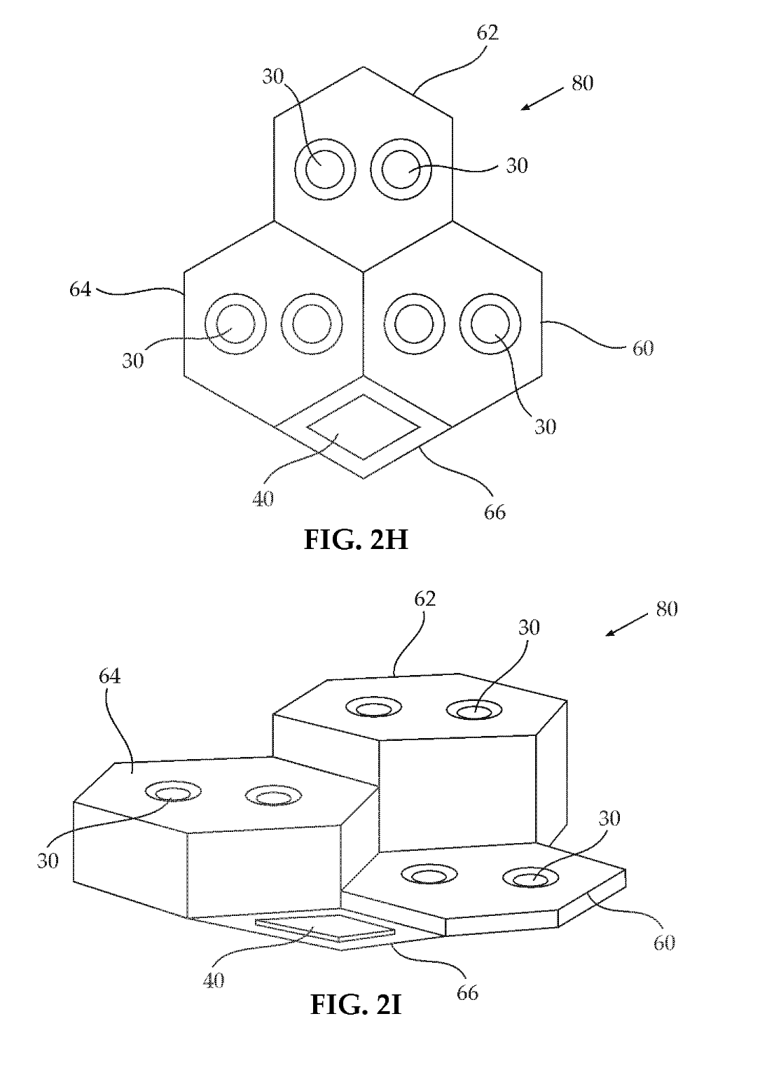

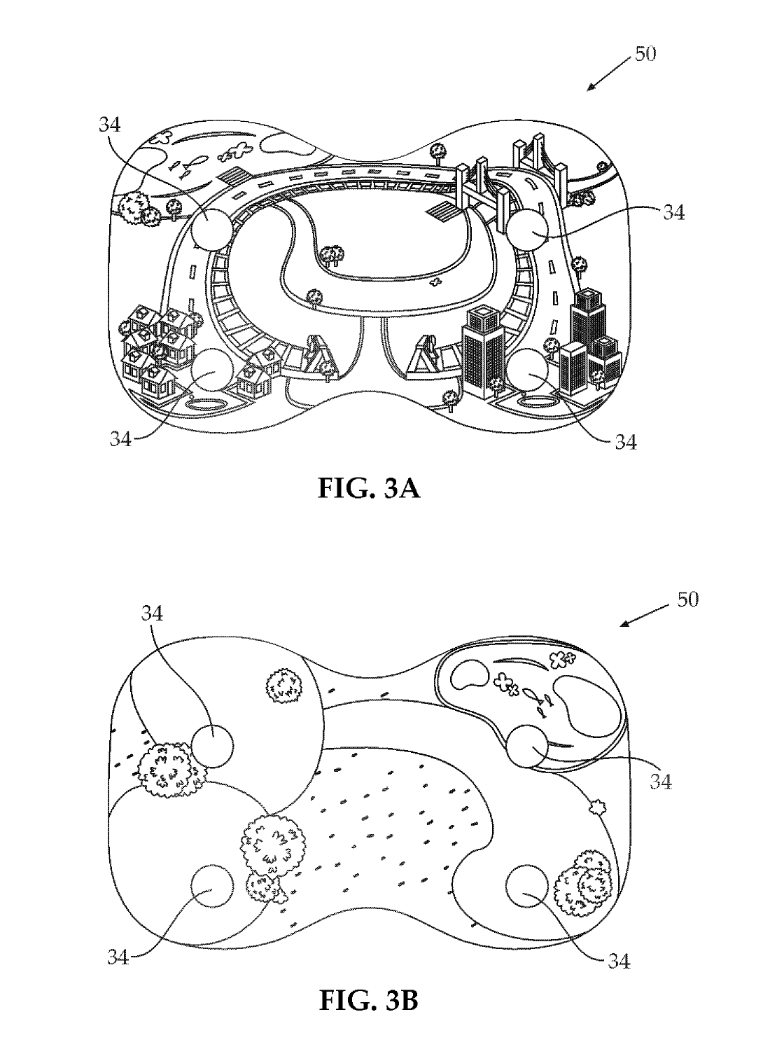

The power supply for operating the modular board may be provided by batteries, by energy harvesting technologies and/or by connecting the board to a standard home use electricity power supply. When the modular board is operated by batteries, the board comprises a batteries compartment that is preferably positioned at the bottom part of the board as illustrated in FIG. 2C. In this embodiment the board can be mobile, when used with a mobile smart device (such as smart watches, smart glasses, tablets, phablets, and smart phones).

### 5. Communication Unit

The communication unit, is configured for commanding a software running on a smart device to display an image of the interactive figures and/or the replaceable toppings on the smart device in a respective position, and further for commanding the software to activate or deactivate the image displayed on the smart device in accordance with the operation of the identifiable object on the game board base. The communication may be established for example, via Wi-Fi.

Alternatively, the modular game board may not include any electronics or Bluetooth, and the smart devices will connect to the game board by a 3D camera (this technology solution is based on visual recognition). In such variation, the device identifies the different elements by their predefined visual features such as but not limited to: color, shape, size, and will respond to the elements in the same matter that was described hereinabove.

Thus, it is appreciated that the board base, in combination with the app, provides the user with an interactive experience having both tangible and virtual dimensions. Actions that the players do with the interactive figures on the board base produce different responses in the smart device. In some preferred embodiments, the user can “play” with the interactive figures on the smart device, and thus produce results, such as sounds or light displays, on the game board base.

### II. Replaceable Toppings

In accordance with the present invention, the user may place a replaceable topping onto the game board base. The topping may be for example: a printed cardboard, a 3D plastic toy, and such, as it is configured to change the theme and appearance of the board according to the user's desire and available toppings. This concept allows the user to enjoy different themes and play patterns on the same modular board base, thereby enhancing the learning/playing experience. For example: a road map cardboard that allows the player to play vehicles games on the board; a safari cardboard that allows the player to play animals games; a 3d plastic castle that allows the player to play with knights & dragons. In accordance with the present invention, the topping may also be a three dimensional topping.

The topping may be a smart component that is recognized by the game board base. In such embodiment, the topping may be used for playing without additional interactive figures. For example, the cardboard of the smart topping may be sliced into pieces and used as a puzzle game that the player should assemble as type of playing.

The smart toppings as well as the non-smart topping may be sliced into pieces in order to allow easy storage and shipment. The topping in any shape and form shall have at least some of the following features:

Shape: The topping structure is designed to fit the board base special structure or parts thereof.

Uncovered electronic components: the topping may also cover or uncover the electronic components of the game board base, by special holes that can reveal the hotspots, LEDs and buttons. This feature may vary between different toppings—some toppings may include many holes that uncover all the hotspots, buttons and LEDs in the board base and some toppings may cover some of them, depending on the functionality of the specific game, the ages it is directed to and the level of complexity.

Clips: The topping may further include special clips on it, configured to allow a user to attach various decorative elements to the topping, after it is set in place on the board. For example: attaching trees to the safari set, or traffic signs to the road set so as to impart the specific topping a sound look of the imitated environment. The decorative elements may be made of any material suitable to be positioned in a stable manner on the board topping including without limitation: plastic, wood, cardboard, and rubber. The elements are designed to fit the clips of the topping. An image of topping and the decorating elements may appear in the app, for example, to help the user in understanding and remembering the different areas of the specific game on the modular game board base, and to enhance the game experience. The clips may be replaced by a recognition component on the board base itself, which can be revealed by the topping, thus allowing identification of the decorative elements. Additionally, in some embodiments the different toppings may comprise a tag, which allow it to be identified by a complementary recognition element that is placed on the board.

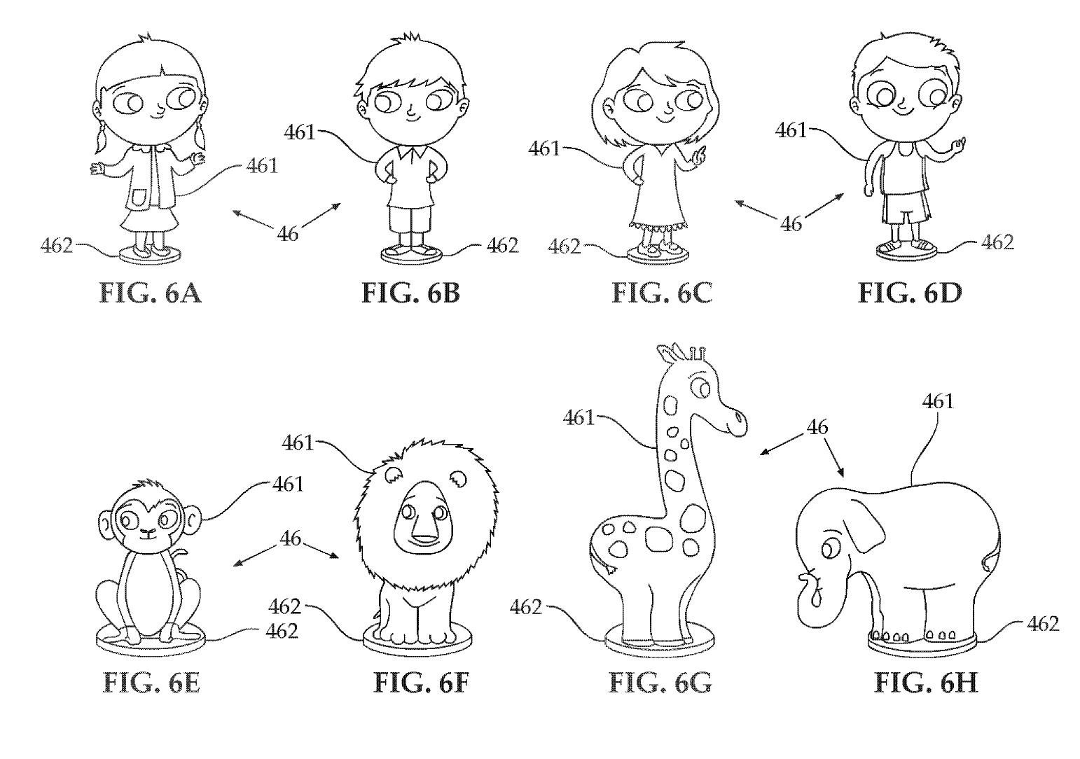

In accordance with variation of the invention, the toppings may include electronic elements, such as hotspots, buttons and LEDs. These features will functionally allow the covers to be an active part of the game. For example: a castle with a tower (FIG. 4), wherein on top of the tower at least one recognition element (such as a hotspot) and at least one active element (such as a cannon and a LED) are positioned. When placing an interactive figure on top of the tower, the figure appears in the app and shoots, and the LED is lightened so as to appear as fire. The cover is replaceable, and therefore the castle can be replaced with ease by an active dollhouse cover, an active safari cover, etc.

In accordance with variations of the invention the modular game board base may include as an integral part thereof one topping that can be covered by other toppings by the player according to the player desire.

### III. Interactive Figures

In accordance with examples of the invention, in order to use the modular board system, the player places an interactive toy figure having a unique tag attached to it (besides in cases that a camera is used for recognition), preferably but not necessarily to the base of the figure, on any hotspot positioned on the game board base. Upon positioning of the interactive figure (and more accurately the tag) on a hotspot, recognition of the specific tag is performed by the app and the specific figure attached to the tag is displayed on the connected interactive smart device. In addition to the display of the figure on the smart device, an accompanying reaction may be actuated on the modular board, the smart device, or on both items. For example, a LED may be lightened on the board or a sound may be played on the smart device, the interactive figure displayed on the smart device may ask the player a question or ask the player to make an action on the board, to tell a story, to sing a song, or to interact with another interactive figure that is also positioned on the play board. Each topping may have a specific set of interactive and decorative figures; however, some toppings may share the same set of figures. A detailed description of interactive figures with tags is provided in PCT/IL2013/000055 of the same inventors.

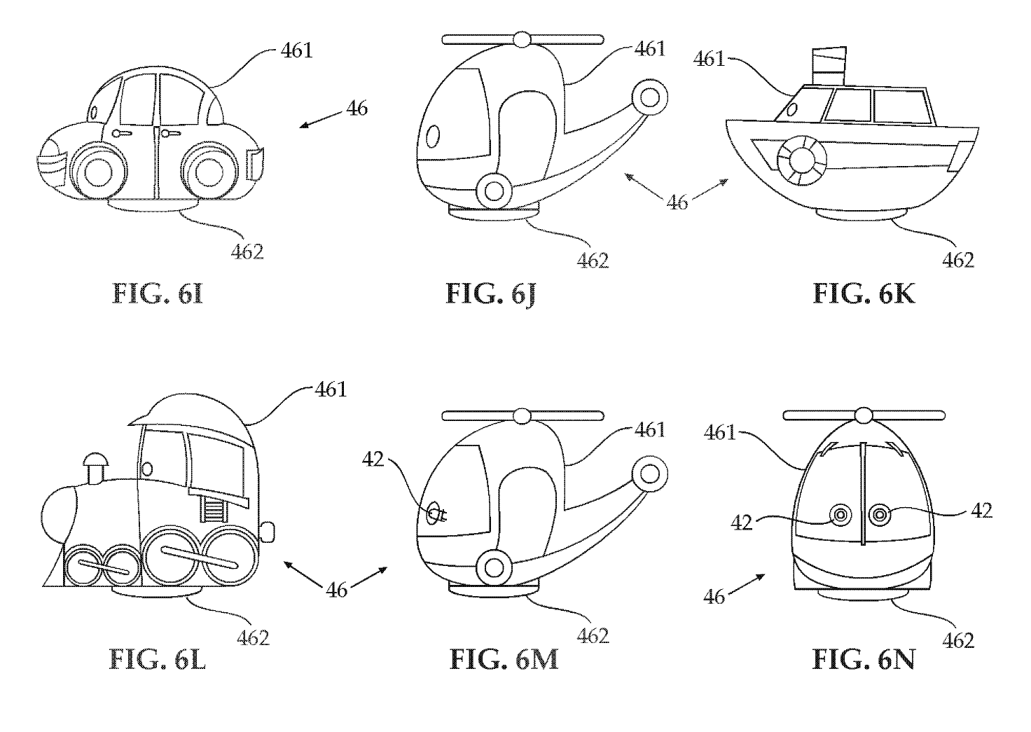

In accordance with additional aspect of the invention, the interactive figures may be smart figures, i.e., the figures themselves may include electronic features, such as mechanics, accelerometer, gyro, speaker, buttons and LEDs (shown in FIG. 5). These active figures open new possibilities for different play patterns. For example: a car figure may be placed on the board. The car appears on the screen, and the front lights of the physical and virtual car lit together. When the physical car is moved on the board, the device identifies the movement and location of the figure on the board. Upon pressing a button located on its roof, the car shoots at enemies.

Another example for such active figure is a figure that upon being placed on the board it may lift its hand to say hello to the screen/player. The virtual figure on screen may then return a wave to the physical figure and to the player.

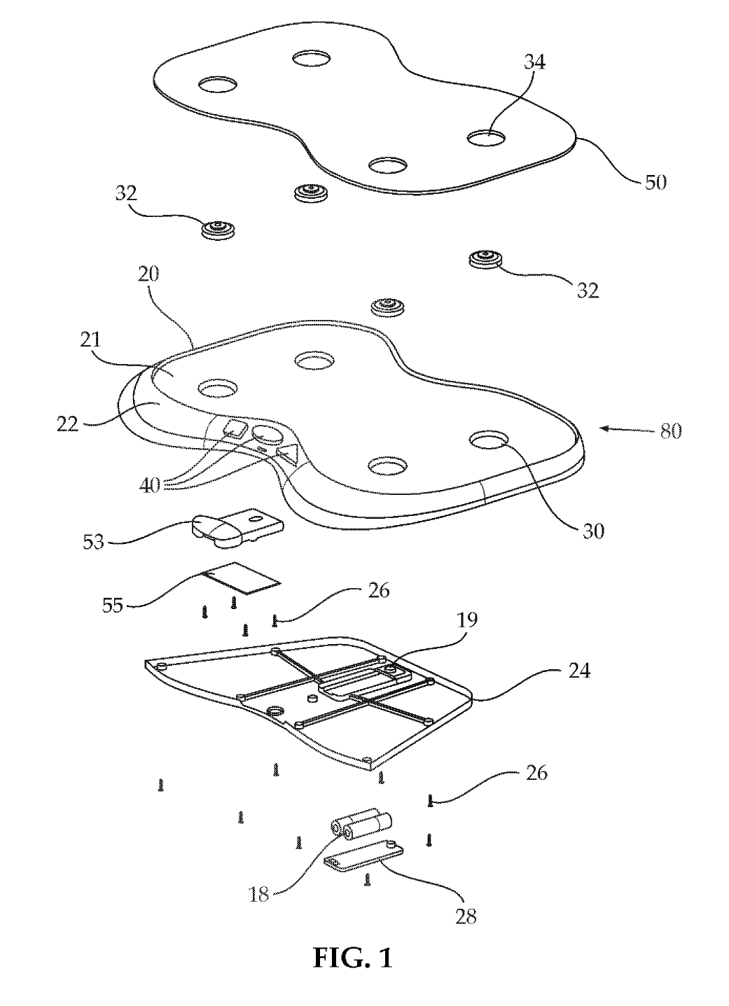

Reference is now made to FIG. 1 that schematically illustrates an exploded view of a modular game board and a replaceable topping. Shown in this figure are: a replaceable topping 50 configured to cover the top surface of the modular game board base 80 having. The replaceable topping comprises holes 34 configured to uncover recognition elements 32 (sensors) embedded within the game board base 80. In the specific example illustrated in this figure, the recognition elements 32 are proprietary sensors of the same inventors as fully disclosed in PCT/IL2013/000055 incorporated herein by reference and denoted herein after “hotspots”. It should be clear that other sensor may be used for the implementation of the present invention and the usage of the hotspot is non-limiting example. Game board base 80 comprises a top surface 21, a circular side surface 22 that its inner side 20 serves as a supporting wall for the replaceable topping 50, holes or sockets for hotspots 30, buttons 40, a compartment for PCB board and batteries 53, a PCB board 55, pins 26 for connecting the PCB board to its compartment, a bottom surface 24 having a cavity 19 for insertion of batteries 18, battery cover 28, and pins 26 for connecting the bottom surface 24 of the board base 80 to the other walls of the housing. Detailed explanation of the various components illustrated in this figure is provided with reference to the other figures hereinbelow.

FIGS. 2A to 2C schematically illustrate one example of a modular game board base 80 in accordance with preferred embodiments of the present invention viewed from top (2A), from bottom (2C), and in an isometric view (2B).

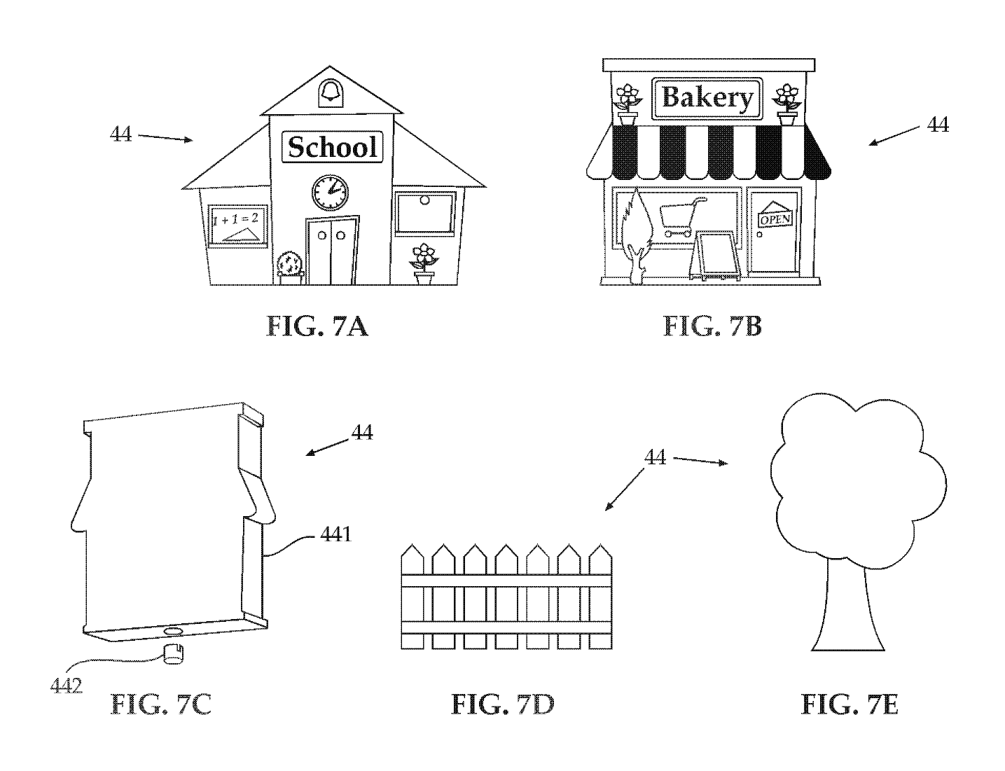

The game board base 80 is composed of a top surface 21, a bottom surface 24, and a circular side wall surface 22 connecting them. The top surface 21 may be blank or have a specific theme. When it has a theme it may serve as an integral topping. Top surface 21 may contain simple holes (or sockets) 30 for holding hotspots 32 that upon attachment to an interactive figure 46 (shown in FIG. 6) allows recognition of the attached figure and production of a response on a connected smart device, and optionally on either one of the game board itself, a smart interactive figure, and a smart decorative elements. The number of holes 30 may vary according to the number of hotspots designed to be embedded in the modular game board base. The more hotspots positioned within the board base, the complexity and variety of the playing/learning options increases. Buttons 40 may be any one of the buttons mentioned in the above. The number of buttons may also vary from a single button to a plurality of buttons. The buttons in the specific example illustrated in FIG. 2 are positioned on side wall 22 and shaped as a set of geometrical shapes, however it is clear that it may be positioned and shaped differently. From bottom view (FIG. 2C), screws 26 are shown, configured to attach the bottom surface 24 of the game board base to the top surface 21. The number and position of the screws may change according to the dimensions and shape of the game board base, and it should be clear that the design shown in this figure is for demonstration only and any other attachment means for connecting the housing's walls may be applicable. From the bottom view, also shown is the cover of the battery compartment 28 and side wall 22 of the board base 80.

FIGS. 2D and 2E, illustrate a game board base 80 shaped as butterfly from top and isometric views. Shown in these examples are the top surface 21 of the game board base 20 comprising holes 30 for hotspot in each of the four sections of the butterfly, side wall of the board base housing 22, and a button 40.

Additional optional implementation of the invention is illustrated in FIGS. 2F and 2G representing top and isometric views of a game board base having an elongated shape and six holes 30 for hotspots. Also shown in these figures are top surface of the base board 21, side wall 22, and button 40.

A further implementation of the game board base is seen in FIGS. 2H (top view) and 2I (isometric view). In this variation, the game board base 80 is modular and is constructed from a plurality of sections, first section 60, second section 62, third section 64 and forth section 66, which together form base 80. The four sections 60, 62, 64 and 66 each have a different height. In this scenario, a different topping can be employed for each of the three sections 60, 62, 64. Section 66 function as a surface for positioning buttons (e.g. button 40). The user has the option of switching only one topping at a time, switching two toppings at a time, or switching all three toppings. There is thus an expanded number of play possibilities with different toppings. Each section 60, 62, 64 can have, as an example, two holes 30 for placing hotspots. Each section may further comprise additional elements such as LEDs, buzzers, and the like (not shown).

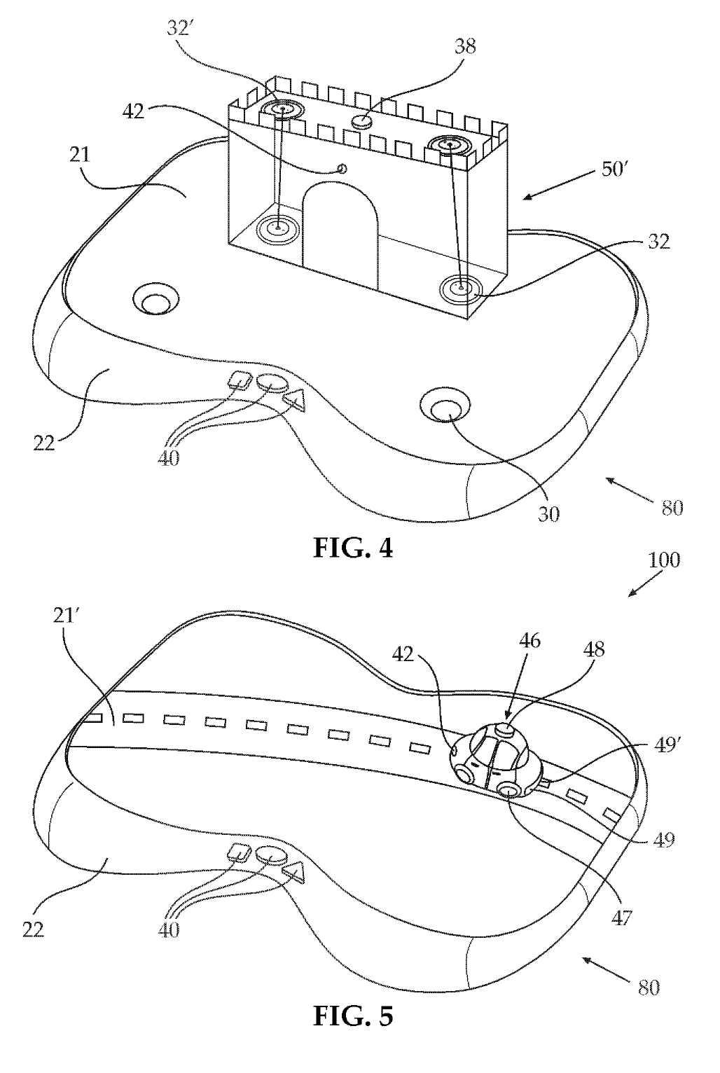

FIGS. 3A and 3B are schematic illustrations of some exemplifying variations of replaceable topping 50. FIG. 3A illustrates an urban environment with a traffic road, and FIG. 3B illustrates a nature setting topping with hills, trees and a river. The board topping comprises holes 34 for uncovering the hotspots.

FIG. 4 is a schematic illustration of an example of a three dimensional (3D) “active” topping designed as a castle positioned on a game board base 80. In the specific example illustrated in this figure, the 3D replaceable topping 50′ is attached to the game board base 80 via hotspots 32 positioned on the base. These hotspots are constructed and operable in a manner that they are attached with hotspots 32′ positioned on the 3D topping so as to create extended hotspots (in a similar way of action of an extension cord). An interactive figures 46 may now be attached either to the board base or to the 3D topping. The 3D topping may further comprise a LED 42 or a plurality of LEDs that are turned on according to the game played in a pre-designed mode. For example, in a knight's battle, the LED may be turned on at each time that the castle absorbs a hit. The castle may further comprise a button 38 configured to allow shooting on a potential enemy on the screen of the connected smart device. It should be clear that the 3D topping 50′ of the present invention may comprise additional visual, audio and mechanic buttons and elements so as to enhance the playing experience of the user. The 3D topping 50′ may cover the entire top surface 21 of the game board base 80 or parts thereof.

FIG. 5 is a schematic illustration of a modular game board 100 having a game board base 80 with an integral topping 21′ and an interactive figure 46 comprising mechanical elements. Interactive figure 46 is shaped as a car and positioned on the top surface of game board base 80 that functions as an integral topping 21′ and designed as a traffic road. The integral topping may be covered by other replaceable toppings to change the theme of the game or simple to change the options that the user have. For example, adding a 3D topping shaped as a bridge or as a traffic interchange (not shown). In the specific example illustrated in this figure, the recognition of the interactive element on the play board is achieved by motion recognition elements and figure recognition element and not by hotspots as described before. In the specific example illustrated in this figure, interactive figure 46 comprises mechanical elements 47 that allow it to move on the game board base and the corresponding app recognizes the motion of the interactive figures on the board and responds accordingly. The interactive car 46 may contain LED 42 configured and operable to be turned on for example, when the weather in the app is foggy or at night time. The mechanical elements 47 are positioned for example, on the wheels and configured to allow the car to travel along the game board. The interactive figure may additionally or alternatively comprise motion recognition elements 49 and figure recognition element 49′ so as to allow recognition of the specific interactive figure and its position on the game board base on the screen of the connected smart device. Additionally or alternatively interactive figure 46 may further comprise a button 48 configured to allow shooting on a potential enemy on the screen or functioning as the buzzer of the car to alert other figures in the app or on the real world i.e., on the board. It should be clear that the buttons and features illustrated hereinabove are only an example and should not be interpreted as limiting the scope of the invention. also shown in this figure are side wall of the game board base 22 and buttons 40.

FIGS. 6A-6L are schematic illustrations of examples of interactive figures 46 in accordance with the invention including, wherein, FIGS. 6A-6D are family set figures with a girl (FIG. 6A), a boy (FIG. 6B, a mother (FIG. 6C), and a father (FIG. 6D); FIGS. 6E-6H are safari set figure with a monkey (FIG. 6E), a lion (FIG. 6F), a giraffe (FIG. 6G), and an elephant (FIG. 6H); FIGS. 6I-6L are traffic vehicles set with a car (FIG. 6I), an helicopter (FIG. 6J), a boat (FIG. 6K), and a train locomotive (FIG. 6L); FIGS. 6M and 6N represent a side view and a front view, respectively, of a smart interactive figure designed as a helicopter with LEDs and mechanical propeller.

Each one of the figures 46 is composed of at least two components: a character 461 (e.g. a boy, a girl, a lion, a monkey, an elephant, a car, a boat, an airplane, a cube, and the like), and a complementary recognition element 462 configured to be attached/recognized by the recognition elements 32, such as the hotspots, that is positioned on the game board base so as to allow identification of the specific figure positioned on the play board and its relative position on the game board base by the app running on the connected smart device. The complementary recognition element 462 is unique to each interactive figure and the processing of the data upon positioning of the interactive figure on the play board base is performed in the game board base 80, thus, the player may connect with the same topping and set of figure to various smart devices available to the player according to its preferences in a given time period. For example, the player may be connected to a tablet and if another member in the family needs the tablet, the payer may connect to a smart T.V. or to a smart phone and proceed with the game at the same course he had before changing the connected smart device, since the “brain” is positioned in the game board base.

The helicopter figure illustrated in FIGS. 6M and 6N has the added optional feature of one or more LED's 42 that light up, for example, upon attachment of the figure to the board or of performance of a certain action with the figure.

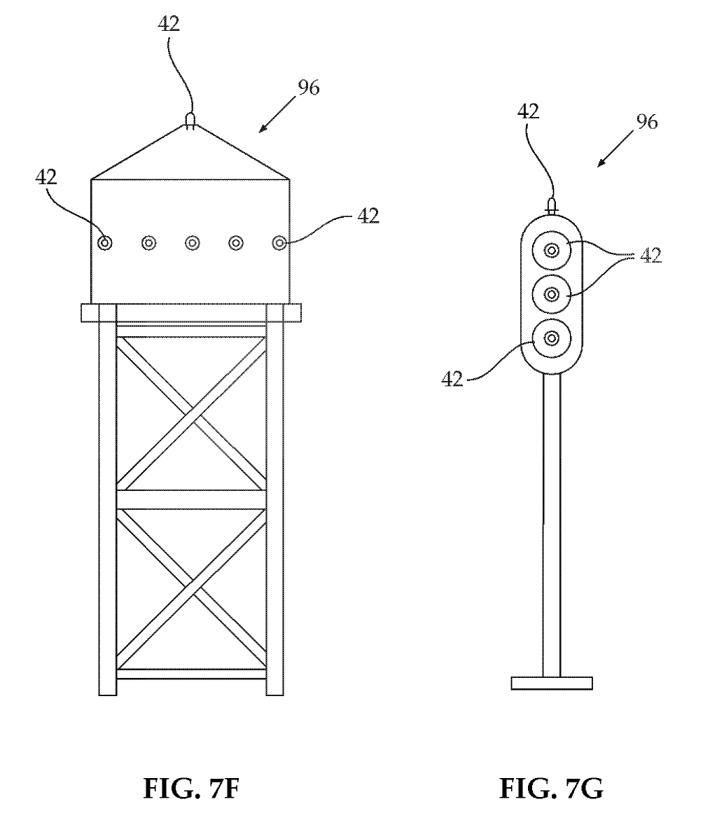

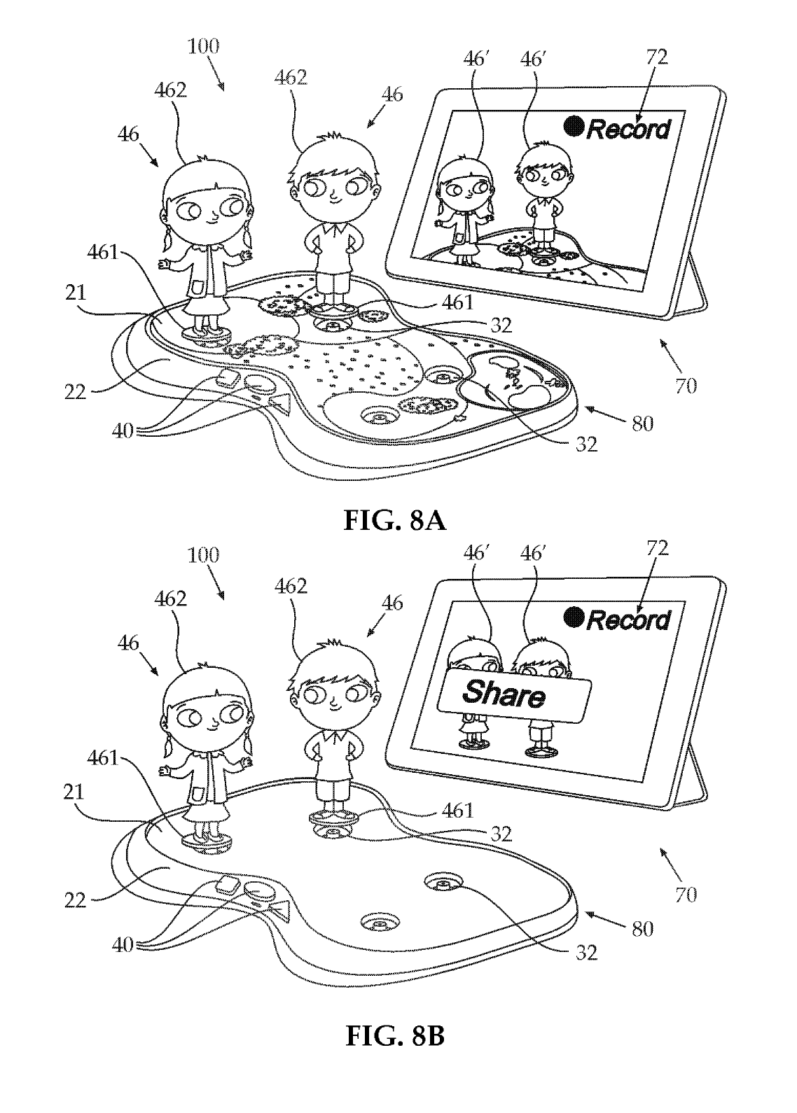

FIG. 7A-7E are schematic illustration of examples of decorative elements 44 for enriching the physical playing environment in accordance with embodiments of the invention, wherein FIG. 7A illustrates a decorative element 44 shaped as a school, FIGS. 7B-7C illustrate another decorative element 44 shaped as bakery viewed from front and rear sides respectively, FIG. 7D illustrates a decorative element 44 representing a fence, and FIG. 7E illustrates a decorative element 44 designed as a tree. It should be clear that the examples shown herein are only few exemplifying options and there are enormous other options for the shape and size of the decorative elements. The decorative elements are configured to enhance the physical playing experience of the user with the game board system and are not configured to be identified by the board base and the app running on the smart device as the interactive figures 46 are. The decorative elements 44 are used for decoration of the play structure only and may vary according to the theme. The decorative figures are physically attached to the modular game board (either to the game board base or to the replaceable topping or to both, by various means such as clips illustrated in FIG. 7C as 441, by magnets, by mechanical complementary configurations, male/female scotch, and any other connecting means suitable for such purpose. The decorative elements may be made from various materials.

The decorative elements may also be smart decorative elements as shown with reference to FIGS. 7F and 7G showing smart decorative elements 96 shaped as a tower, and a s a traffic light capable of performing a reaction in the physical toy. More specifically, tower 96, and traffic light 98, each is having a plurality of LEDs 42. The LEDs 42 are configured to be lit up upon performance of certain actions by the user.

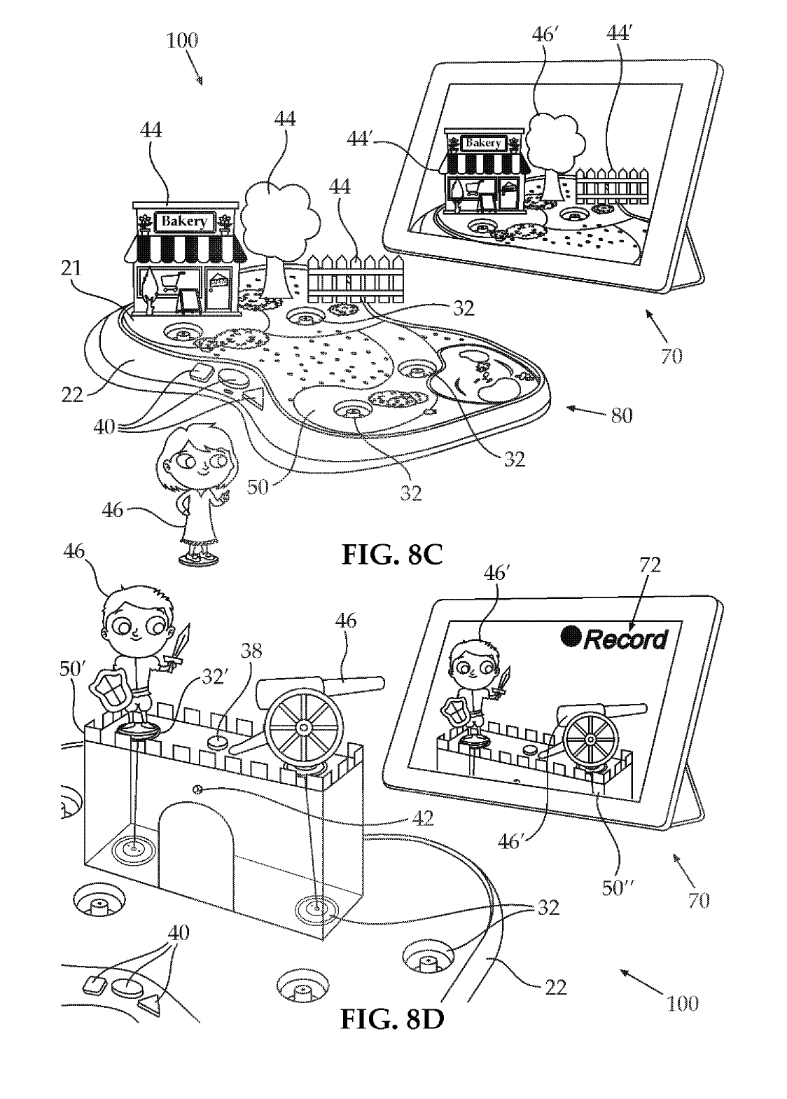

Reference is now made to FIGS. 8A to 8D that illustrate examples of the modular game board system of the invention.

FIGS. 8A and 8B schematically illustrating the modular game board system 100. In the specific example illustrated in these figs. system 100 comprising a game board base 80, two interactive figures 46, and a tablet 70. When an interactive figure 46 is placed on a hotspot 32 on the game board base 80, a record 72 starts in the app running on the smart device, and the character on the screen 46′ starts a lip-sync animation sequence (a microphone listens and/or analyzes sound features). The player may record his/her own voice as the talking character. When a second interactive figure 46 is placed, the matching character 46′ appears and starts its own lip sync sequence (waiting for the player to record). By detaching and attaching the interactive figures from the hotspots on the game board, the player may transfer the speech from one character to the other. By detaching the figure completely, the interactive figure is removed from of the picture on the smart device screen. The app may also contain a pre-set timer, which measures the length of the detach action; if the action is short, and followed by an attach event, the character on the screen 46′ may starts speech animation without disappearing from the screen.

This method of play allows the player to create stories and videos, by only playing a natural game in the real world; children usually play with figures and imagine stories and adventures, built from smaller conversations between the characters. This allows them to play naturally with their toys, with or without touching the screen for recording.

As seen in FIG. 8B, the stories or songs may further be saved, shared on the web, and shared 74 with other users of the app. Furthermore, other users may download the stories to their app and enlarge their stories variety about the physical toys that the child owns. These stories may be suitable for the players' demographics by nature (for example, a Swedish child might want to download stories about his hometown, made by Swedish children from the same town). All other components shown in these figures have the same function as previously described with reference to FIGS. 1 to 7.

FIG. 8C illustrate another non-limiting playing option for the modular game board system 100 of FIGS. 8A and 8B. In FIG. 8C a replaceable topping 50 was added to the game board base 80, and tree decorative elements were used to decorate the playing environment. In this example, the smart device 70 “speaks” to the player and directs him/her to place the interactive figure 46, a girl, to walk around the decorative elements 44 positioned on the game board base, for example, to buy a cake at the bakery, to go to a walk near the tree and to open the fence. The reality of the game board 80 is reflected in the display on the smart device.

FIG. 8D illustrate another example of the modular game board system 100 of the invention. in this example a 3D replaceable topping 50′ shaped as a castle was placed on the game board base 80, and two interactive figures 46 were placed on top of the castle a solder and a cannon. The user can record a story that is related to the interactive figures that are part of the play display. The stories may further be played by placing the various figures on various positions on the board base 80. And buttons, LEDs and buzzers may further be operated.

As a non-limiting example the recording player started the story by putting, for example, a solder near the cannon and upload it to the web, the player that downloaded the story will have to put the solder near the identical cannon in his own toy to start playing the story. This method of story-initiating may also work with built-in stories and other forms of videos downloaded from the server.

The recordings may further include diverse interactive play patterns, such as but not limited to building a sentence-to-sentence story; the first player puts a figure on the board, records a sentence and sends it to another player through the web. The second player builds the second sentence, and so on.

The recordings may further include addible sound effects, animations, mood changes to the characters and changeable environments and backgrounds.

This unique system allows a more natural imaginative play, which suits the pediatrics and psychologists recommendations regarding developing kids imagination and creativity. Virtual games have the ability to record stories, but they are limited to a play on the screen, which is sometimes less natural and intuitive for children. Bringing this play pattern to the physical toys' world creates a new game experience.

Another way of engaging with the present invention is by using a Branching path story structure for built-in stories. In this proposed play pattern, the story might offer the player a number of alternative paths for the storyline, and the player may choose by placing the figure in his chosen path. For example, if the story starts with Winnie the Pooh who is looking for a new adventure, the player may put the physical Pooh toy in Eeyore's house, or maybe in the rabbit's hole. In each case the story will continue according to the player's choice. The story may further comprise quizzes, riddles, missions in other places in the toy and may involve other characters and other play sets, all controlling the development of the game through the physical toy.

This module of game may also use the detach-reattach mechanism in order to enrich the game options, for example:
a) Detach-reattach to jump to get an apple from a tree;
b) Detach-reattach several times in a specific frequency in order to dance on the hotspot (the hotspot identifies the frequency and reacts differently to the multi attach-detach behavior)
c) Detach and reattach to another hotspot. The character will walk from one place to another in a special form and without disappearing. For example, when a soldier is detached and reattached quickly to another hotspot, the virtual soldier will move so quickly between the hotspots so that the enemies won't see him.
d) Attach-detach timer that measures the time of the attachments, for example, putting cannon on a charging station after it's out of ammunition in order to charge it. The charging should take a minute. The attach timer will recognize and will alert when the charging is done and the cannon is ready.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1.-43. (canceled)

44. A modular game board system for providing interactive play with a smart device, comprising:
(a) a game board base configured and operable to communicate with at least one smart device and with at least one element of a playing kit;
(b) a playing kit comprising at least one replaceable topping adapted to be placed onto said game board base, each topping constitutes a unique game display and/or at least one interactive figure associated with said unique game display; and
(c) a software program for activating or deactivating the interaction of the game board base with the smart device and the at least one element of the playing kit;
wherein, the game board base is configured and operable to allow recognition of the identity and the position of said at least one element of the playing kit on the board, such that upon placement of said element on the game board base, said game board base transmits said identity and the position of the element to the smart device, causing at least a performance of an image of said element displayed on the smart device.

45. A modular game board system according to claim 44, wherein said playing kit comprises a plurality of replaceable topping pieces constituting together a unique game display, and/or a plurality of interactive figures related to a unique game theme, or a mixture thereof.

46. A modular game board system according to claim 44, wherein said playing kit comprises at least one replaceable topping and at least one interactive figure, all related to a unique game theme.

47. A modular game board system according to claim 44, wherein said playing kit further comprises non identifiable decorative elements configured to decorate the game board base and topping of the unique game theme.

48. A modular game board system according to claim 44, wherein said at least one smart device is selected from a group consisting: smart phones, smart televisions, tablets, phablets, PC, and smart wearable devices and wherein, said playing kit is accompanied by a software application dedicated to the smart device being in use.

49. A modular game board system according to claim 44, wherein said game board base has at least one recognition element for recognizing either one of the interactive figure and the replaceable topping that are being placed thereon.

50. A modular game board system according to claim 49, wherein said recognition element is at least one hotspot configured to allow identification of said at least one replaceable topping and/or interactive figure when either one of them or both are placed onto said at least one hotspot.

51. A modular game board system according to claim 44, wherein each of said at least one interactive figures and/or replaceable topping has a unique tag for facilitating recognition of said figure or topping by the game board base.

52. A modular game board system according to claims 44, wherein said game board base further comprises at least one of the following components: buttons, LEDs, microphone, buzzer, and speaker, and wherein upon recognition of said interactive figure and/or said topping and display of its image on the smart device a further reaction is performed by the smart device and/or by the game board base.

53. A modular game board system according to claim 44, wherein the game board base has a modular construction, which allow users to change the topping and interactive figures used with the board, thus allowing them to use the same physical board with multiple games.

54. A modular game board system according to claims 44, wherein said game board base is comprised of two or more segments having varying heights.

55. A modular game board system according to claims 44, further comprising at least one smart interactive figure having at least one electric component that creates a reaction on the interactive figure itself upon usage.

56. A modular game board system according to claim 44 further comprising attachment means for facilitating attachment thereto of said at least one topping.

57. A modular game board system according to claim 44, wherein said topping comprises at least one 3D standing element.

58. A modular game board system according to claim 44, wherein said replaceable topping is a 3D topping comprising an extension of sensors configured to allow identification of interactive figures positioned on top of it.

59. A modular game board system according to claim 44 further comprising:
(a) a sensor configured for sensing the location of said at least one interactive figure and/or the location of said replaceable topping;
(b) a processing unit configured for receiving the sensor signals and for determining the identity and the location of said at least one interactive figure and the identity and the location of said replaceable topping based on said signals; and
(c) a communication module, said communication module being configured for commanding a software running on said smart device to display an image of said interactive figure and/or said replaceable topping on said smart device in a respective position, and for commanding said software to activate or deactivate said image in accordance with operation of said interactive figures on said game board base, so as to simulate the environment of the modular game board to the display on the smart device.

60. A modular game board system according to claim 59, wherein activating said image includes at least one one member of a group consisting of: moving the image of the interactive figure, playing an animation, playing a video clip, playing a recording file, and communicating with a social network.

61. A modular game board system according to claim 59, wherein the image of the interactive figure displayed on the smart device is either one of the following: a picture of the interactive figure and/or the replaceable topping, an animation of the interactive figure and/or replaceable topping reflecting the reality of the game board base, animation of a story that involves the interactive figures positioned at a specific moment on the board base, a song or a movie involving the interactive figures that are in use, and connection to external software.

62. A modular game board comprising a generic game board base and at least one identifiable object, wherein the game board base is configured to allow recognition of the identity and the position of the at least one identifiable object on the game board base upon positioning of said at least one identifiable objects on the game board base, and wherein, an image of said identifiable object is displayed on a smart device in a respective position, said smart device comprising a software program for identifying the identifiable object, and activating or deactivating the interaction of the game board base, the smart device, and the identifiable object, wherein said at least one identifiable object is either one of a replaceable topping adapted to be placed on said game board base, said topping constitutes a unique game display, or an interactive figure associated with said unique game display, or both.

63. A modular game board according to claim 62, wherein the image of the identifiable object displayed on the smart device is either one of the following: a picture of the identifiable object, an animation of the identifiable object reflecting the reality of the game board base, animation of a story that involves the identifiable objects positioned at a specific moment on the board base, a song and/or a movie involving the identifiable objects that are in use, and connection to external software.

64. A modular game board according to claim 62, wherein upon recognition of said identifiable object and display of its image on the smart device a further reaction is performed by the smart device and/or by the game board base.

65. A modular game board according to claims 62, wherein said game board base further comprises at least one of the following components: buttons, LEDs, microphone, buzzer, and speaker.

66. A modular game board according to claim 62, wherein the game board base has a modular construction, which allows a user to change the topping and the interactive figures used with the board, thus allowing said user to use the same physical board with multiple games.

67. A modular game board according to claim 62, wherein said game board base is comprised of two or more segments having varying heights.

68. A modular game board according to claim 62, further comprising at least one smart interactive figure having at least one electric component that creates a reaction on the interactive figure itself upon usage.

69. A modular game board according to claims 62, further comprising attachment means for facilitating attachment thereto of said at least one identifiable object to the game board base.

70. A modular game board according to claim 62, wherein said replaceable topping comprises at least one 3D standing element, and/or a 3D topping comprising an extension of sensors configured to allow identification of interactive figures positioned on top of it.
